(19) United States
(12) Patent Application Publication
(10) Pub. No.: US 2002/0115439 A1
(43) Pub. Date: Aug. 22, 2002

(54) Management of location information

(76) Inventors: Kari Hotakainen, Pirkkala (FI); Tuija Vikman, Lempaala (FI)

Correspondence Address: PILLSBURY WINTHROP, LLP, P.O. BOX 10500, MCLEAN, VA, 22102, US

(21) Appl. No.: 10/082,357

(22) Filed: Feb. 26, 2002

Related U.S. Application Data
(63) Continuation of application No. PCT/FI00/00734, filed on Aug. 30, 2000.

(30) Foreign Application Priority Data
Sep. 1, 1999 (FI) 19991861

(51) Int. Cl. H04Q 7/20

(52) U.S. Cl. 455/435; 455/461

(57) ABSTRACT

An intelligent network system and a method for processing location information in an intelligent network system connected to a telecommunication system, the location information being composed of digits. A symbol mask is attached to the location information and the values of the symbols indicate the relevance of each digit to processing the location information. The symbol mask is attached to reference location information and other location information comprised by the intelligent network is compared to the symbol values of the symbol mask of the reference location information such that, responsive to the comparison, the location information is obtained wherein the digits indicated to be relevant by the symbol values of the symbol mask of the reference location information equal corresponding digits of the reference location information. The obtained location information is processed according to predetermined commands.

This application is a Continuation of International Application PCT/FI00/00734 filed on Aug. 30, 2000 which designated the U.S. and was published under PCT Article 21(2) in English.

The invention relates to management and processing of location information in telecommunication systems, especially in mobile communication systems.

Mobile communication systems are typically cellular systems, i.e. the coverage area of a mobile network consists of cells, the coverage area of each cell being served by a base transceiver station (BTS) and each cell usually slightly overlapping with neighbouring cells. The whole mobile network is controlled by one or more network management systems (NMS). In order to be able to control and monitor the mobile network, NMS has to know the identification of each cell. Moreover, there may exist cell-specific services in mobile networks. In order to check whether they are allowed to use these services, mobile stations have to be aware of the identification of cells providing cell-specific services. Thus, the cell identity has to be delivered from the mobile network to mobile stations being located in a particular cell area.

In GSM system (Global System for Mobile Communication) each cell is uniquely identified by a CGI code (Cell Global Identity). The CGI code is a standard format of 14 digits, containing Mobile Country Code (MCC), Mobile Network Code (MNC), Location Area Code (LAC) and Cell Identity (CI). The CGI code is formed to hierarchically define the country by the first four digits (MCC), the mobile network by the next two digits (MNC), the location area, i.e. a group of cells determining the location approximately, by the next four digits, and the exact cell by the last four digits. Consequently, CGI code is normally used as a cell location information in intra-system communication between the elements of a GSM network.

Intelligent networks (IN) have been introduced into mobile communication networks in order to enable quick and flexible implementation of new telecommunication services. INs separate the network intelligence from the physical switching and transport entities of mobile networks through defined protocols and interfaces. Data protocols, messages and data formats used in IN communication are not bound by the mobile network standards, but the mobile network operator may define its own way of processing network data inside the intelligent network. The usual approach is that existing mobile network data is modified into a more flexible format to be used in IN. For example, in prior known intelligent networks, cell location data is expressed either by the CGI code as such or by replacing one or more digits from the end of the CGI code by a so-called wild card (*). The beginning of the CGI code is always defined exactly by so many digits as required for a specific purpose. For example, a service could be defined for every cell in a certain location area by determining the CGI code in the service definition message as 358f 24 6666 where 358f is the value for MCC, 24 for MNC and 6666 for LAC. The wild card (*) after the LAC definition tells that this service definition message concerns every cell in this particular location area. Respectively, by determining the CGI code as 358f 24 6666 1* the service definition message would concern every cell in this location area (6666), of which first digit of CI is 1.

The problem involved with the arrangement described above is the limited usability of the wild card. The prior known INs are designed in such way that a wild card can only be used at the end of the CGI code replacing any number of digits from one to fourteen. A wild card (*) cannot be used in the middle of the CGI code as it would be impossible to tell how many and which digits are replaced, especially if several wild cards are used. Thus it is not possible to define certain parts or digits at the beginning or in the middle of the CGI code as being relevant. However, mobile network related intelligent networks (Mobile INs) comprise several network elements which store, deliver and utilise at least some of the location information contained by CGI codes. In some cases, only a part of CGI codes, for example LAC information, is changed, and this change must be updated in several network elements. Because a wild card cannot be used to replace the LAC part of the CGI code, each CGI code must be transferred and updated a whole, resulting in unnecessary data transmitting and processing, which is always exposed to errors. Furthermore, some future services e.g. in GSM environment will enable direct communication between the elements of the intelligent network and mobile stations. Some of these services involve delivering cell information from the IN to a mobile station, which information, according to prior known solutions, would contain the whole CGI code, although the mobile station only requires the CI part of the CGI code. Therefore, the 14-digit CGI code consumes unnecessarily the limited memory of the mobile station. Altogether, the limited usability of the wild card complicates the utilisation of location information in various applications, which would require more flexible approach to processing of location information.

Thus, an object of the invention is to provide a method and means for eliminating the problems described above. The invention relates to a method for processing location information in an intelligent network system connected to a telecommunication system, particularly to a mobile communication system, the location information being composed of digits. The method is characterized by

attaching a symbol to each digit of the location information to indicate the relevance of said digit to the processing purpose and

processing at least one digit of the location information indicated to be relevant according to predetermined commands.

The invention further relates to an intelligent network system comprising coupling means for linking the intelligent network system to a telecommunication system, transmission means for transmitting location information between said intelligent network system and said telecommunication system, the location information being composed of digits, processing means for processing and modifying the location information into a form suitable for the intelligent network system, entering means for an operator of the intelligent network system for entering commands to process the location information, and storing means for storing the location information. The intelligent network system according to the invention is characterized in that

said processing means are arranged to

attach a symbol to each digit of the location information to indicate the relevancy of said digit for the processing purpose and

process at least one digit of the location information indicated to be relevant according to predefined commands.

The invention is based on the idea that there is a symbol attached to each digit of the location information, in other words a symbol mask is attached to the location information, which symbol mask is used inside intelligent network for indicating which digits of the location information are considered relevant to a specific purpose. Preferably, the symbols are bits, but any other symbols, like letters, numbers or special characters, could also be used.

An advantage of the method and the IN system according to the invention is that the relevant digits of the location information can be indicated digit by digit. Any digit can thus be defined relevant, regardless of its position in the location information and its relationship to other relevant digits. Several digits, which do not necessarily have to be in a consecutive order, can be indicated to be relevant. Also digits at the beginning and in the middle of the location information can either be included in or neglected from the relevant digits. Furthermore, the invention considerably reduces the amount of data to be transferred and processed. Another advantage of the invention is that it can be applied to all processing of location information inside the intelligent network. According to a preferred embodiment of the invention, the symbol mask is removed from the location information prior to transmitting the location information to the telecommunication system. Yet another advantage of the invention is that it facilitates the direct communication of location information between the intelligent network and the terminal of the telecommunication system needed in some applications. The transmitted location information can be shortened according to an advantageous embodiment of the invention, consequently reducing the memory consumption of the very limited memory of the mobile equipment or the SIM card.

A more detailed embodiment of the invention is provided by the following description of preferred embodiments given by way of example and to be understood in conjunction with the accompanying drawings, in which:

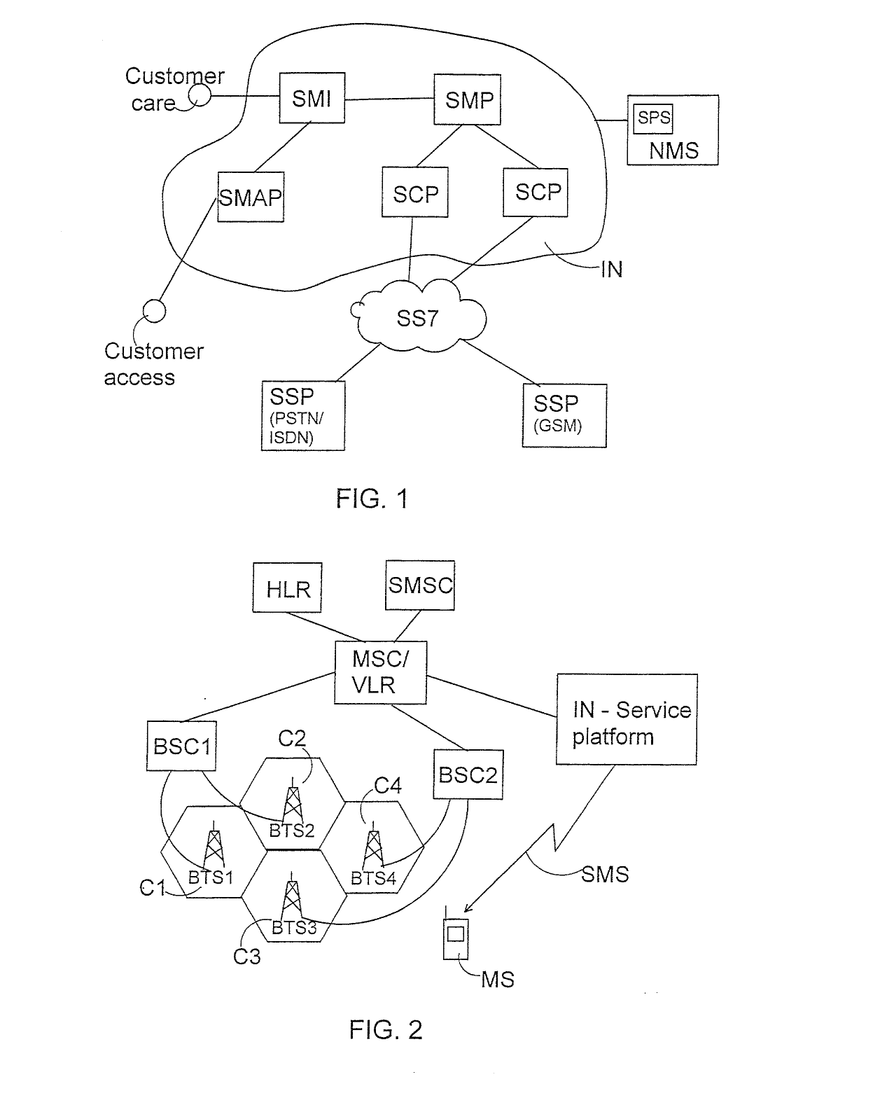

FIG. 1 shows a block diagram of an implementation of an intelligent network in a telecommunication system;

FIG. 2 shows a simplified block diagram of an implementation of a Mobile IN service application;

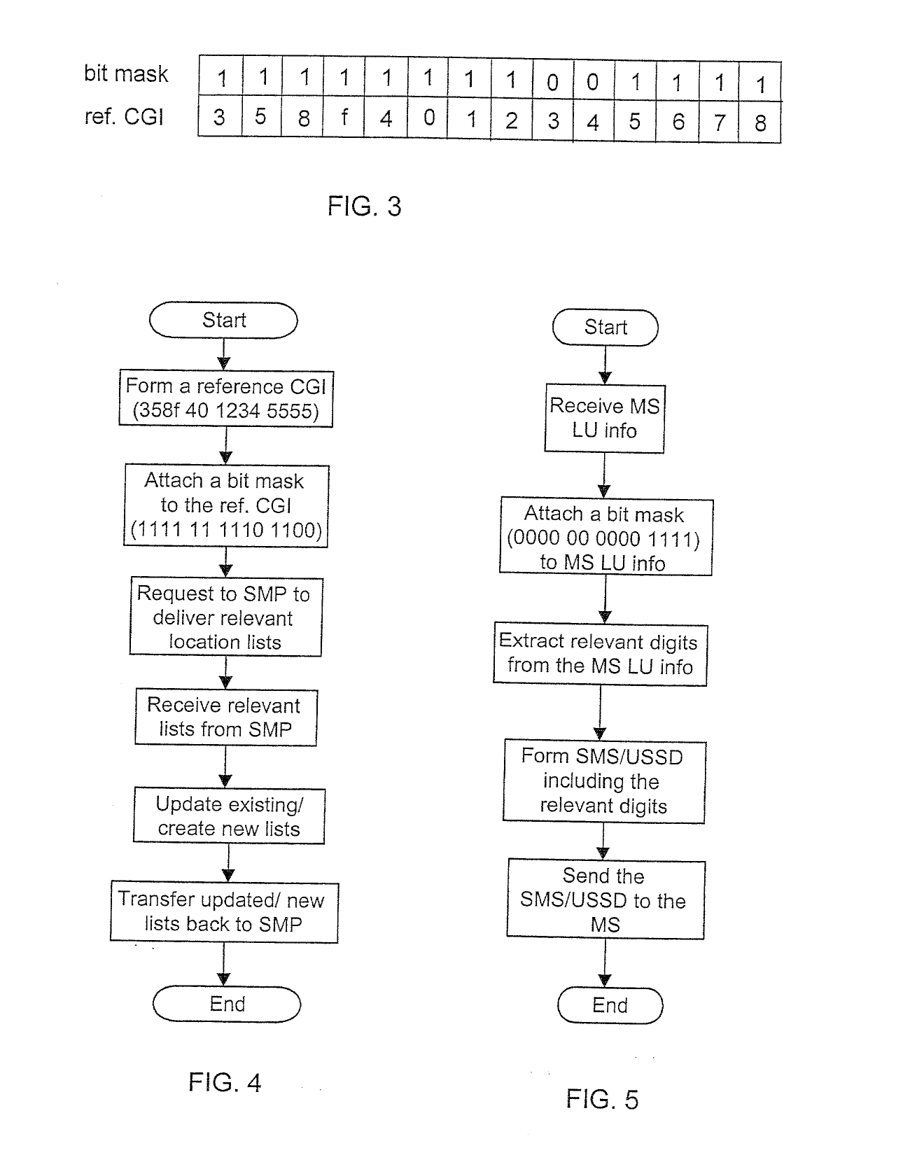

FIG. 3 shows a table diagram of a preferred embodiment of the invention;

FIG. 4 shows an exemplary flow diagram of a preferred embodiment of the invention;

FIG. 5 shows another exemplary flow diagram of a preferred embodiment of the invention.

In the following, reference is made to FIG. 1, which shows an example of how an intelligent network can be implemented in telecommunication networks. Intelligent networks implemented in connection with mobile communication networks are usually called Mobile IN networks. The implementation in FIG. 1 should be regarded as an example and it is obvious for a man skilled in the art that the invention can also be carried out in any other corresponding network configuration.

In FIG. 1, the Intelligent Network (IN) is connected to a GSM architecture through a signalling network, which typically supports Signalling System No. 7 (SS7). The same IN can also be connected to a wired telecommunication network, like PSTN (Public Switched Telephone Network) or ISDN (Integrated Services Digital Network). In the GSM network, SS7 network is connected to Service Switching Points (SSPs), which can be implemented e.g. in connection with Mobile Switching Centres (MSC; not shown). SSPs are IN-capable switching systems, which can detect requests for IN-based services and establish connections to IN service logic located at the Service Control Point (SCP). The SCP can co-operate with several SSPs in different phases of call processing, from validation through call set-up to call termination. It can also control non-call services, such as location updates. The Service Management Point (SMP) provides service management support and customer control capabilities for IN services. The SMP provides the functions needed to control and administer IN service features, service subscriber data and service configurations. In addition, the SMP allows the operators to tailor an IN service and its features to meet their individual needs. Intelligent networks typically include a service creation tool which allows the operator to quickly create novel services, taking advantage of predetermined database structures based on the standard data structure of the mobile networks, as explained previously in regard to CGI codes.

Service Management Interface (SMI) is typically a software-based interface between the service and subscriber databases in the IN and customer (i.e. service providers) management applications. SMI is typically a secured system including limited user rights, user IDs and passwords. Third party service providers can access SMI to install and update their own services. Service Management Access Point (SMAP) enables the mobile subscribers to view and update their own service information.

Several kinds of location based services have been developed for mobile networks. For example, in GSM networks, with the support of intelligent networks, a concept of Localised GSM Services (LGS) has been developed. LGS allows network operators and service providers to offer subscriber-specific tariffs and services in selected geographical areas. Mobile subscribers can have several Location Service Area (LSA) subscriptions, like “home zone” or “office zone”, where the subscriber is entitled to reduced tariffs or special services.

FIG. 2 is a simplified block diagram showing how LGS system architecture can be implemented. FIG. 2 shows a mobile station MS and four GSM network cells, C1-C4, which are served by base transceiver stations BTS1-BTS4, respectively. Base stations BTS1 and BTS2 are controlled by base station controller BSC1 and base stations BTS3 and BTS4, in turn, by base station controller BSC2. Base station controllers BSC1 and BSC2 are connected to a mobile switching centre (MSC), which is responsible for e.g. connection set-up and call routing. The MSC is supported by two databases, which comprise mobile subscriber information: a home location register (HLR), which comprises data on all subscribers of the mobile telephone network and the services they have subscribed, and a visitor location register (VLR), which comprises data on all subscribers currently visiting the MSC. The MSC is further connected to a Short Message Service Centre (SMSC), which provides short message services (SMS) needed in some LGS applications. In addition, there is a signalling connection from the MSC to IN Service Platform, which can be e.g. an IN system explained in FIG. 1. In regard to a more specific description of the GSM system, reference is made to ETSI/GSM specifications and to The GSM system for Mobile Communications, M. Mouly and M. Pautet, Palaiseau, France, 1992, ISBN:2-957190-07-7.

The operator of the GSM network can manage the Location Service Area definitions located in the SMP through a Service Positioning System (SPS), which is typically part of the GSM Network Management System (NMS; shown in FIG. 1). A more detailed description of the SPS is disclosed in the patent application WO 99/12226. LSAs are defined on the basis of the radio network coverage of the GSM network. Let us suppose that LSA1 is defined to cover cells C2 and C3 and the subscriber to the mobile station MS has made a LSA subscription to LSA1. A home location register HLR contains LSA subscription information on all subscribers in the network. When the mobile station MS arrives at the coverage area of LSA1, i.e. in cell C2 or C3, the GSM system triggers, in a manner known per se, the LGS applications located in the IN Service Platform. The IN comprises lists of all LSA subscriptions and more accurate information on tariffs and services, which will be applied to the MSs when in the area of their LSA. IN, typically the SCP, also informs the MS of arrival at the area of its LSA by sending an SMS or USSD (Unstructured Supplementary Service Data) message directly to the MS. The MS stores the LSA information in the memory of the mobile equipment or in the SIM-card (Subscriber Identity Module) connected to the MS and displays the LSA identification to the user of the MS. When the MS moves in the area of LSA1, the base station controllers BSC1 and BSC2 are arranged to support the handover between the cells of the LSA1.

FIG. 3 shows a preferred embodiment of the invention. A bit mask of 14 bits is formed, each bit corresponding to a digit of a CGI code. The bit mask enables to indicate which digits of a CGI code are relevant to a specific purpose. For example, the relevant digits of the CGI code can be indicated by setting the value of the corresponding bit at 1, and the irrelevant digits can be indicated by setting the value of the corresponding bit at 0, respectively. The bit values can naturally be defined vice versa. FIG. 3 shows a reference CGI code and a bit mask attached thereto. In this example, CGI code 358f 40 1234 5678 corresponds bit mask 1111 11 1100 1111, consequently indicating that the last two digits of the LAC can have any value, but the other twelve digits of a CGI code must match with the aforementioned CGI code. With the help of the bit mask, each digit can be separately defined as relevant or irrelevant to some specific purpose. Irrelevant digits, represented by a wild card (i.e. bit value 0), do not necessarily have to be in the end of the CGI code, but any one of the digits can be defined as irrelevant.

The previous example of the invention shows a preferred way of utilising bits or a bit mask to indicate the relevant digits. The information contained by bits is readily in a computer-readable form, thus being a natural choice for facilitating the processing of location information. However, it is obvious that also any other symbols, like certain letters, numbers or special characters, could be used to indicate the relevancy of the location information digits.

The invention provides a flexible way of defining several irrelevant CGI code digits, which do not necessarily have to be in a consecutive order. In many IN-based services, the data management inside the IN service platform requires handling of only a part of the CGI code, e.g. only LAC can be subject to changes, the rest of the CGI remaining the same. Also the signalling between the IN and the mobile network can be simplified in some cases by transferring only a part of a CGI code. These advantageous embodiments of the invention are illustrated in the following examples.

The following examples relates to location information management in Mobile IN applications. Location lists containing information on different LSAs and LSA subscriptions of the mobile subscribers are stored in the SMP. The LSA definitions of the location lists can be updated internally by the network operator, for example when the cell coverage of an LSA has been changed due to changes in radio network configurations. This can be done by the SPS operator, i.e. the person responsible for the Service Positioning System (SPS). On the other hand, external system operators, i.e. the service providers, can update the LSA subscriptions of the mobile subscribers through the SMI. Depending on the service, LSA definitions can contain relevant location information regarding at least, but not limited to the following formats:

the whole CGI code (MCC+MNC+LAC+CI)

Location Area Code+Cell Identity (LAC+CI)

Cell Identity (CI)

Mobile Country Code+Mobile Network Code+Cell Identity (MCC+MNC+CI)

Mobile Country Code+Mobile Network Code+Location Area Code (MCC+MNC+LAC)

Location Area Code (LAC)

Mobile Country Code+Mobile Network Code (MCC+MNC).

The SPS operator can create new location lists and update or delete the existing location lists. Location lists are also stored in the SPS database, and whenever changes are made directly to the SMP, e.g. by an external system operator, the changes have also to be updated in the SPS database. The invention provides a flexible tool for all tasks relating to location list management.

In the example of a preferred embodiment of the invention, illustrated by FIG. 4, location lists have to be updated due to network configuration changes. New microcells with smaller coverage area are introduced into a regional area, which was previously covered by a dozen of larger cells belonging to two location areas with adjacent LAC numbers. Now over a dozen of new cells have to be included into network configurations. New location lists have to be created in the SPS and the relevant existing location lists have to be first transferred from the SMP to the SPS and then updated in the SPS. First, a reference CGI code (358f 40 1234 5555) is chosen and formed in the SPS in such way that all relevant information is included. Then a bit mask (1111 11 1110 1100) is attached to the reference CGI code showing the relevant and the irrelevant digits of the CGI code. Because the two location areas, which previously covered the regional area into which new cells are now being introduced, have adjacent LAC numbers, only the last digit of the LAC can vary. The number of related cells is more than ten and cells inside the two consecutive location areas can have adjacent CI numbers. Thus, all relevant cells are covered if the bit mask only allows the last two digits of the CI to vary. The SPS sends a request to the SMP to deliver all location lists which include the location information defined by the reference CGI code and its bit mask. Finally, all relevant location lists according to the definition are transferred from the SMP to the SPS, where the existing lists are updated, new lists are created and said lists are transferred back from the SPS to the SMP. Theoretically, if BCD coded hexadecimal numbers are used, 4096 different combinations of the location information defined by the above-mentioned CGI code and the bit mask could be found in the SMP. In comparison with the prior known solutions, the request definition of the relevant location information should be made as 358f 40 123*, resulting in 1 048 576 different combinations in theory. Consequently, the invention considerably reduces the amount of data to be transferred and processed.

Another example of a preferred embodiment of the invention is shown in FIG. 5. In the future, it will be a requirement in some Mobile IN related Localised GSM Services that a LGS-attached mobile station must be sent cell information. The MS has to be aware of the identification of cells providing cell-specific services in order to check whether it is allowed to use the services. Also the LSA identification is normally displayed to the user of the MS. The transmission of the cell information is typically carried out by an SCP, which sends an SMS or a USSD message containing the required cell information to the MS, which in turn stores the cell information in the memory of either the mobile equipment or the SIM card. According to the prior art, the transmitted cell information would contain the CGI code as such, because there are no means for separating only the end of the CGI code or defining the beginning of the CGI code as irrelevant. In FIG. 5, the SCP receives MS location update information from the GSM network when the MS enters a new cell in the SCP service area. The SCP receives the location information as a CGI code. The service logic in the SCP attaches a bit mask to the CGI, the bit mask being of form 0000 00 0000 1111. Thus, the bit mask defines only the CI part of the CGI code as relevant. Then the SCP extracts the four CI part digits from the CGI code and includes them into an SMS or a USSD message to be sent to the MS. The MS receives the message and the cell information attached thereto. For displaying purposes, the cell information is first stored in the memory and then displayed to the user of the MS. The cell information only comprises four digits instead of 14 digits, consequently reducing the memory consumption of the very limited memory of the mobile equipment or the SIM card.

The preferred embodiments of the invention described above are only examples of how the invention could be utilised. The invention can be carried out using any kind of processing of location information inside an intelligent network. It must be noted that advantageously the bit mask is not delivered outside the IN, but it is only used to facilitate the internal data processing of the IN. Despite the previous examples explained in regard of a GSM network, it is clear that the invention can be implemented in any corresponding network. Consequently, the invention could be used in connection with, for example, a DCS (Digital Cellular System) network, a combination of GSM and DCS networks (so-called dual-band network) or a UMTS (Universal Mobile Telecommunication System) network. Although the invention is primarily meant to be implemented in connection with mobile communication systems, it is also possible that a terminal of a mobile communication system can be connected to a wired network, like PSTN or ISDN via a cable or wirelessly, the wired network being further connected to said IN. In such a case the location information could be defined and delivered to the IN for further processing by the wired telephone system.

It is obvious for a man skilled in the art that as technology advances, the basic idea of the invention can be carried out in numerous ways. Thus, the invention and its embodiments are not limited by the previous examples but they may vary within the scope of the appended claims.

What is claimed is:

1. A method for processing location information in an intelligent network system connected to a telecommunication system, especially to a mobile communication system, the location information being composed of digits, the method comprising
attaching a symbol to each digit of the location information to indicate the relevance of said digit to the processing purpose, and
processing at least one digit of the location information indicated to be relevant according to predefined commands.

2. A method according to claim 1, the method further comprising
forming reference location information,
attaching a symbol to each digit of the reference location information, the symbols forming a symbol mask and the values of said symbols being defined by an operator of the intelligent network system, and indicating the relevance of the digits to processing the location information,
comparing location information comprised by said intelligent network to the symbol values of said symbol mask of the reference location information such that, as a response to said comparison, the location information is obtained wherein the digits indicated to be relevant by the symbol values of said symbol mask of the reference location information equal corresponding digits of said reference location information, and
processing said obtained location information according to predetermined commands.

3. A method according to claim 2, the method further comprising removing the attached symbol mask from the location information prior to transmitting said location information from the intelligent network to said telecommunication system.

4. A method according to claim 2, the method further comprising separating the relevant digits from the obtained location information for further processing.

5. A method according to claim 4, the method further comprising transmitting said relevant digits from the intelligent network to a terminal of the telecommunication system.

6. A method according to claim 1, wherein said telecommunication system is a GSM system and said location information is a CGI code.

7. A method according to claim 1, wherein said method is implemented in connection with Localised GSM Services (LGS).

8. A method according to claim 1, wherein said symbols are presented by bits.

9. An intelligent network system comprising coupling means for linking the intelligent network system to a telecommunication system, transmission means for transmitting location information between said intelligent network system and said telecommunication system, the location information being composed of digits, processing means for processing and modifying the location information into a form suitable for the intelligent network system, entering means for an operator of the intelligent network system to enter commands for processing the location information, and storing means for storing the location information, wherein said processing means are arranged to
attach a symbol to each digit of the location information to indicate the relevance of said digit to the processing purpose and process at least one digit of the location information indicated to be relevant according to predefined commands.

10. An intelligent network system according to claim 9, wherein said processing means are arranged to
form reference location information,
attach a symbol to each digit of the reference location information, the symbols forming a symbol mask and the value of said symbol being defined by said commands and indicating the relevance of the digit to processing the location information,
compare location information in said storing means to the symbol values of said symbol mask of the reference location information such that, as a response to said comparison, location information is obtained wherein the digits indicated to be relevant by the symbol values of said symbol mask of the reference location information equal corresponding digits of said reference location information, and
process said obtained location information according to predetermined commands.

11. An intelligent network system according to claim 10, wherein said processing means or said transmitting means are arranged to remove the attached symbol mask from the location information prior to transmitting said location information from the intelligent network system to said telecommunication system.

12. An intelligent network system according to claim 10, wherein said processing means are arranged to separate the relevant digits from the obtained location information for further processing.

13. An intelligent network system according to claim 12, wherein said transmitting means are arranged to transmit said relevant digits from the intelligent network system to a terminal of the telecommunication system.

14. An intelligent network system according to claim 9, wherein said telecommunication system is a GSM system, and said location information is a CGI code.

15. An intelligent network system according to claim 9, wherein said intelligent network system supports the implementation of Localised GSM Services (LGS).

16. An intelligent network system according to claim 9, wherein said symbols are presented by bits.
